(19) United States
(12) Patent Application Publication
(10) Pub. No.: US 2019/0040743 A1
(43) Pub. Date: Feb. 7, 2019

(54) TURBINE WHEEL, RADIAL TURBINE, AND SUPERCHARGER

(71) Applicant: MITSUBISHI HEAVY INDUSTRIES ENGINE & TURBOCHARGER, LTD., Sagamihara-shi, Kanagawa (JP)

(72) Inventors: Toyotaka YOSHIDA, Tokyo (JP); Takao YOKOYAMA, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 16/075,779

(22) PCT Filed: Mar. 2, 2016
(86) PCT No.: PCT/JP2016/056381

§ 371 Date: Aug. 6, 2018

(51) Int. Cl. F01D 5/14

(52) U.S. Cl. CPC F01D 5/141; F05D 2240/303; F05D 2240/301; F05D 2220/40

(57) ABSTRACT

Suction surfaces of blades of this radial turbine each have: a leading edge side of blade tip including a leading edge and the boundary between the suction surface and the tip; and a trailing edge side of blade tip including a trailing edge and the boundary between the suction surface and the tip. The leading edge side of blade tip forms a concave curved surface which is recessed towards the side opposite to the rotation side in a radial view. The trailing edge side of blade tip forms a convex curved surface which protrudes towards the rotation side in a radial view.

### TECHNICAL FIELD

The present invention relates to a turbine wheel, a radial turbine, and a turbocharger.

### BACKGROUND ART

A turbine includes a turbine rotary shaft which is rotated about an axis, a turbine wheel which is fixed to an outer peripheral side of the turbine rotary shaft, and a housing which covers the turbine wheel. The turbine wheel includes a disk which is fixed to the turbine rotary shaft and a plurality of blades which are provided on an outer peripheral surface of the disk at intervals in a circumferential direction. In portions between the plurality of blades, a working fluid flows in from a portion between leading edges of the blades. The working fluid flows out from a portion between trailing edges of the blades.

In a radial turbine, a leading edge of a blade faces a radially outer side with respect to an axis. In addition, a trailing edge of the blade faces a rear side in an axial direction in which an axis extends. Accordingly, in the radial turbine, the working fluids flows in from a radially outer side and is extracted to the rear side in the axial direction.

For example, as the radial turbine, there is a radial turbine disclosed in the following PTL 1. A pressure surface of the radial turbine forms a concave curved surface which is recessed to a rotation side from the pressure surface toward a suction surface. In addition, the suction surface forms a convex curved surface which protrudes to the rotation side.

### CITATION LIST

[PTL 1] Japanese Unexamined Patent Application Publication No. 2004-011560

### SUMMARY OF INVENTION

### Technical Problem

In a turbine, a turbine wheel is rotated relative to a housing, and thus, there is a gap between a tip of a blade and an inner peripheral surface of the housing. In general, this gap is referred to as a tip clearance. In order to increase turbine efficiency, it is preferable to set the tip clearance as small as possible. However, due to axial vibrations, thermal expansion of the turbine wheel, or the like, there is a limit to a reduction of the tip clearance to avoid a contact between the tip of the blade and the inner circumferential surface of the housing.

In the turbine, reducing a flow of a working fluid through the tip clearance, that is, reducing a clearance flow leads to improvement in the turbine efficiency. Accordingly, an object of the present invention is to provide a turbine wheel, a radial turbine, and a turbocharger capable of reducing the clearance flow.

### Solution to Problem

In order to achieve the above-described object, according to a first aspect of the present invention, there is provided a turbine wheel including: a disk which has a shape rotationally symmetrical about an axis and a diameter which gradually decreases from a front side which is one side in an axial direction in which the axis extends toward a rear side which is the other side; a plurality of blades which are fixed to an outer peripheral surface of the disk at intervals in a circumferential direction D with respect to the axis, in which each of the blades includes a leading edge which extends in a direction including an axial component from a portion on the front side of the disk and faces a radially outer side with respect to the axis, a trailing edge which extends in a direction including a radial component with respect to the axis from a portion on the rear side of the disk and faces the rear side, a pressure surface and a suction surface which extend from the leading edge to the trailing edge and face sides opposite to each other, a tip which forms an edge on a side far from the outer peripheral surface, the suction surface includes a leading edge side of blade tip including a boundary between the suction surface and the tip and the leading edge and a trailing edge side of blade tip including a boundary between the suction surface and the tip and the trailing edge, the leading edge side of blade tip forms a concave curved surface which is recessed to an counter-rotation side from the suction surface toward the pressure surface when viewed in a radial direction, and the trailing edge side of blade tip forms a convex curved surface which protrudes to a rotation side from the pressure surface toward the suction surface side when viewed in the radial direction.

There is a gap referred to as a tip clearance between the tip of the blade in the turbine wheel and an inner peripheral surface of a turbine housing covering the turbine wheel. A flow of a working fluid through the tip clearance, that is, a presence of a clearance flow leads to a decrease in turbine efficiency.

Here, a blade in which the entire suction surface is a convex curved surface protruding to the rotation side is defined as Comparative Example. In Comparative Example, as a result of the clearance flow, a leakage fluid which has flowed from a pressure surface side of the blade to a suction surface side becomes a vortex flow, and flows along the suction surface of the blade. The flow of the leakage fluid along the suction surface of the blade attracts the clearance flow.

Meanwhile, in the turbine wheel, the leading edge side of blade tip in the suction surface of the blade is the concave curved surface which is recessed to the counterrotation side. Accordingly, in the turbine wheel, a separation angle of the clearance flow with respect to the suction surface in the present embodiment is larger than a separation angle of the clearance flow with respect to the suction surface in Comparative Example. Accordingly, in the turbine wheel, most of the leakage fluid flowing to the suction surface side of the blade through the tip clearance in the portion on the leading edge side of the blade is not attached to the suction surface of the blade and flows to be separated from the suction surface. In this way, in the turbine wheel, most of the leakage fluid flows to be separated from the suction surface of the blade, and thus, it is possible to suppress attraction of the clearance flow. As a result, compared to Comparative Example, in the turbine wheel, it is possible to reduce the clearance flow and increase the turbine efficiency.

In the turbine wheel according to a second aspect of the present invention in order to achieve the above-described object, in the turbine wheel of the first aspect, the suction surface has a root portion which includes a boundary between the suction surface and the outer peripheral surface, the leading edge, and the trailing edge, and is in contact with the leading edge side of blade tip and the trailing edge side of blade tip, and the root portion forms a convex curved surface which protrudes to the rotation side.

In the turbine wheel according to a third aspect of the present invention in order to achieve the above-described object, in the turbine wheel of the second aspect, a boundary line between the leading edge side of blade tip and the root portion is positioned at a position which is less than half a blade height from the tip in a blade height direction.

In the turbine wheel according to a fourth aspect of the present invention in order to achieve the above-described object, in the turbine wheel of any one of the first to third aspects, the leading edge side of blade tip and the trailing edge side of blade tip are in contact with each other, and a boundary line between the leading edge side of blade tip and the trailing edge side of blade tip on a tip line formed at a boundary between the tip and the suction surface is positioned at a position at which a distance from the leading edge to the boundary line is equal or more than half the entire length of the tip line.

In the turbine wheel according to a fifth aspect of the present invention in order to achieve the above-described object, in the turbine wheel of any one of the first to fourth aspects, a curvature radius of the concave curved surface in the leading edge side of blade tip is equal to or more than a curvature radius of the convex curved surface in the trailing edge side of blade tip.

In the turbine wheel according to a sixth aspect of the present invention in order to achieve the above-described object, in the turbine wheel of any one of the first to fifth aspects, the pressure surface includes a leading edge side of blade tip including a boundary between the pressure surface and the tip and the leading edge and a trailing edge side of blade tip including a boundary between the pressure surface and the tip and the trailing edge, the leading edge side of blade tip of the pressure surface forms a convex curved surface which protrudes to the counterrotation side when viewed in the radial direction, and the trailing edge side of blade tip of the pressure surface forms a concave curved surface which is recessed to the rotation side when viewed in the radial direction.

According to a seventh aspect of the present invention in order to achieve the above-described object, there is provided a radial turbine including: the turbine wheel according to any one of the first to sixth aspects; a turbine rotary shaft which extends in the axial direction about the axis and to which the turbine wheel is fixed; and a turbine housing which covers the turbine wheel to be rotatable.

According to an eighth aspect of the present invention in order to achieve the above-described object, there is provided a turbocharger including: the radial turbine according to the seventh aspect; and a compressor, in which the compressor includes a compressor rotary shaft which is rotated about the axis, an impeller which is fixed to the compressor rotary shaft, and a compressor housing which covers the impeller, in which the turbine rotary shaft and the compressor rotary shaft are positioned on the same axis to be connected to each other and are integrally rotated with each other to form a turbocharger rotary shaft.

### Advantageous Effects of Invention

According to an aspect of the present invention, it is possible to reduce the clearance flow.

### BRIEF DESCRIPTION OF DRAWINGS

FIG. 1 is a cross-sectional view of a turbocharger in an embodiment of the present invention.

FIG. 2 is a main cross-sectional view of a radial turbine in the embodiment of the present invention.

FIG. 3 is a development view of a turbine wheel in the embodiment of the present invention.

FIG. 4 is a perspective view of the turbine wheel in the embodiment of the present invention.

FIG. 5 is an explanatory view showing a flow of a working fluid in the radial turbine in the embodiment of the present invention.

FIG. 6 is an explanatory view showing a flow of a working fluid in a radial turbine in Comparative Example.

### DESCRIPTION OF EMBODIMENTS

Hereinafter, an embodiment of a turbocharger according to the present invention will be described with reference to the drawings.

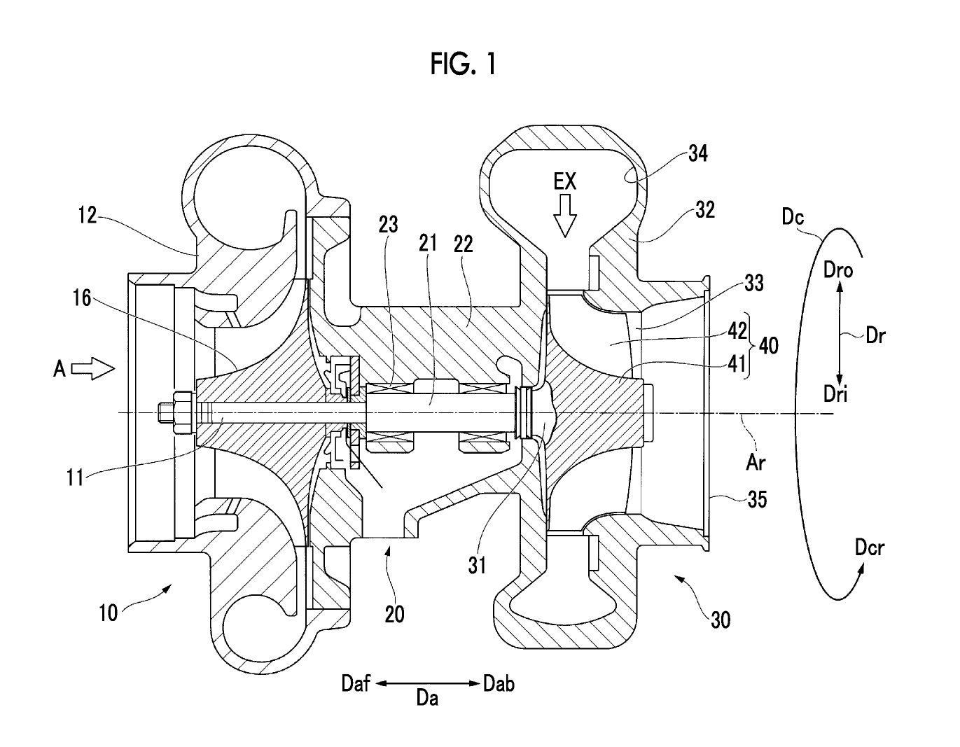

As shown in FIG. 1, the turbocharger of the present embodiment includes a compressor 10 which compresses air A and feeds an engine, a radial turbine 30 which is driven by an exhaust gas EX from the engine, and a connection portion 20 which connects the compressor 10 and the radial turbine 30 to each other.

The compressor 10 is a columnar compressor rotary shaft 11 which is rotated about an axis Ar, a compressor impeller 16 which is attached to an outer periphery of the compressor rotary shaft 11, ad a compressor housing 12 which covers the compressor impeller 16.

The radial turbine 30 includes a turbine rotary shaft 31 which is rotated about the axis Ar, a turbine wheel 40 which is attached to the turbine rotary shaft 31, and a turbine housing 32 which covers the turbine wheel 40.

The connection portion 20 includes a columnar connection rotary shaft 21 which is rotated about the axis Ar, a center housing 22 which covers the connection rotary shaft 21, and a bearing 23 which rotatably supports the connection rotary shaft 21. The bearing 23 is fixed to an inner peripheral side of the center housing 22.

The axis Ar of the compressor rotary shaft 11, the axis Ar of the connection rotary shaft 21, and the axis Ar of the turbine rotary shaft 31 are disposed so as to be arranged in this order on the same axis Ar. The compressor rotary shaft 11, the connection rotary shaft 21, and the turbine rotary shaft 31 are connected to each other to be integrally rotated, and form a turbocharger rotary shaft. In addition, the compressor housing 12, the center housing 22, and the turbine housing 32 are connected to each other so as to form a turbo-charger housing.

Here, a direction in which the axis Ar extends is referred to as an axial direction Da, one side in the axial direction Da is referred to as an axially front side Daf, and the other side in the axial direction Da is referred to as an axially rear side Dab. In the present embodiment, the compressor 10 is provided on the axially front side Daf with respect to the connection portion 20 and the radial turbine 30 is provided on the axially rear side Dab with respect to the connection portion 20. In addition, a radial direction with respect to the axis Ar is simply referred to as a radial direction Dr, a side far from the axis Ar in the radial direction Dr is referred to as a radially outer side Dro, and a side close to the axis Ar in the radial direction Dr is referred to as a radial inner side Dri. In addition, a circumferential direction about the axis Ar is simply referred to as a circumferential direction Dc. A side on which the turbine wheel 40 is rotated in the circumferential direction Dc is referred to as a circumferentially rotation side Dcr.

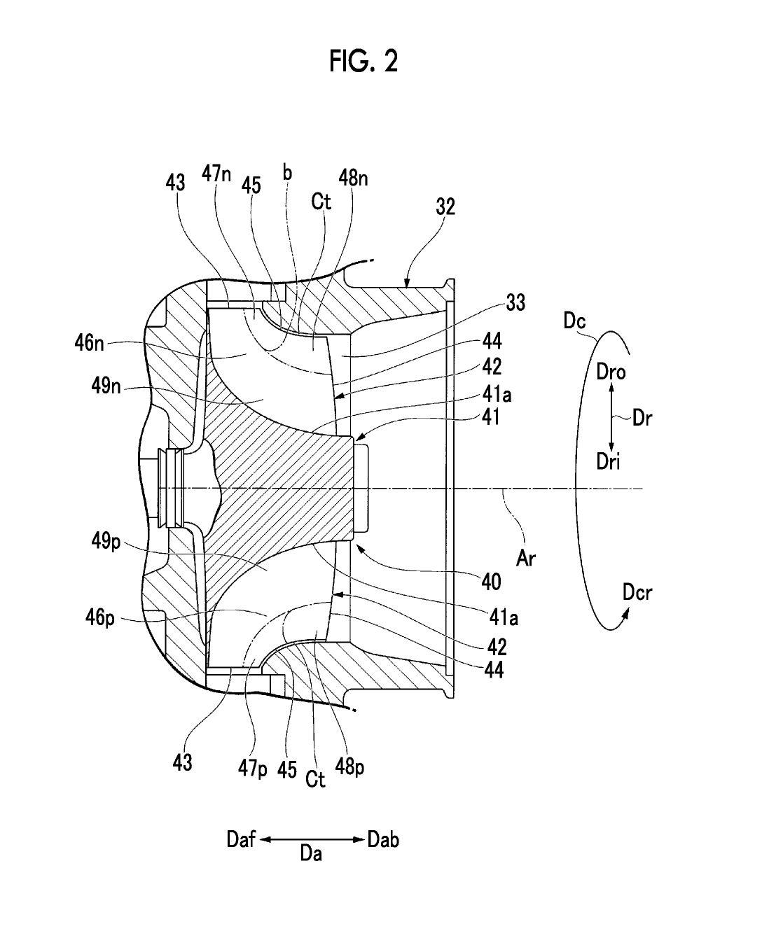

As shown in FIGS. 2 to 4, the turbine wheel 40 includes a disk 41 and a plurality of blades 42. The disk 41 has a shape rotationally symmetrical about the axis Ar and a diameter of the disk 41 gradually decreases toward the axially rear side Dab. The plurality of blades 42 are fixed to an outer peripheral surface 41a of the disk 41 at intervals in the circumferential direction Do.

As shown in FIGS. 2 and 4, each of the blades 42 includes a leading edge 43, a trailing edge 44, a tip 45, a pressure surface 46p, and a suction surface 46n. The leading edge 43 extends in a direction including an axial component from a portion on the axially front side Daf of the disk 41 and faces the radially outer side Dro. The trailing edge 44 extends in a direction including a radial component from a portion on the axially rear side Dab of the disk 41 and faces the axially rear side Bab. The pressure surface 46p and the suction surface 46n extend from the leading edge 43 to the trailing edge 44 and face sides opposite to each other. Accordingly, the pressure surface 46p and the suction surface 46n are in a back-to-back relationship. The suction surface 46n faces the circumferentially rotation side Dcr and the pressure surface 46p faces a side opposite to the circumferentially rotation side Dcr. The tip 45 of the blade 42 is an edge on a side far from the outer peripheral surface 41a of the disk 41.

The suction surface 46n includes a leading edge side of blade tip 47n, a trailing edge side of blade tip 48n, and a root portion 49n. The leading edge side of blade tip 47n is a portion which includes a boundary between the tip 45 and the suction surface 46n, and the leading edge 43. The trailing edge side of blade tip 48n is in contact with the leading edge side of blade tip 47n and is a portion which includes the boundary between the tip 45 and the suction surface 46n, and the trailing edge 44. The root portion 49n is in contact with the leading edge side of blade tip 47n and the trailing edge side of blade tip 48n, and is a portion which includes a boundary between the outer peripheral surface 41a of the disk 41 and the suction surface 46n, the leading edge 43, and the trailing edge 44. In the suction surface 46n, the leading edge side of blade tip 47n, the trailing edge side of blade tip 48n, and the root portion 49n do not overlap each other.

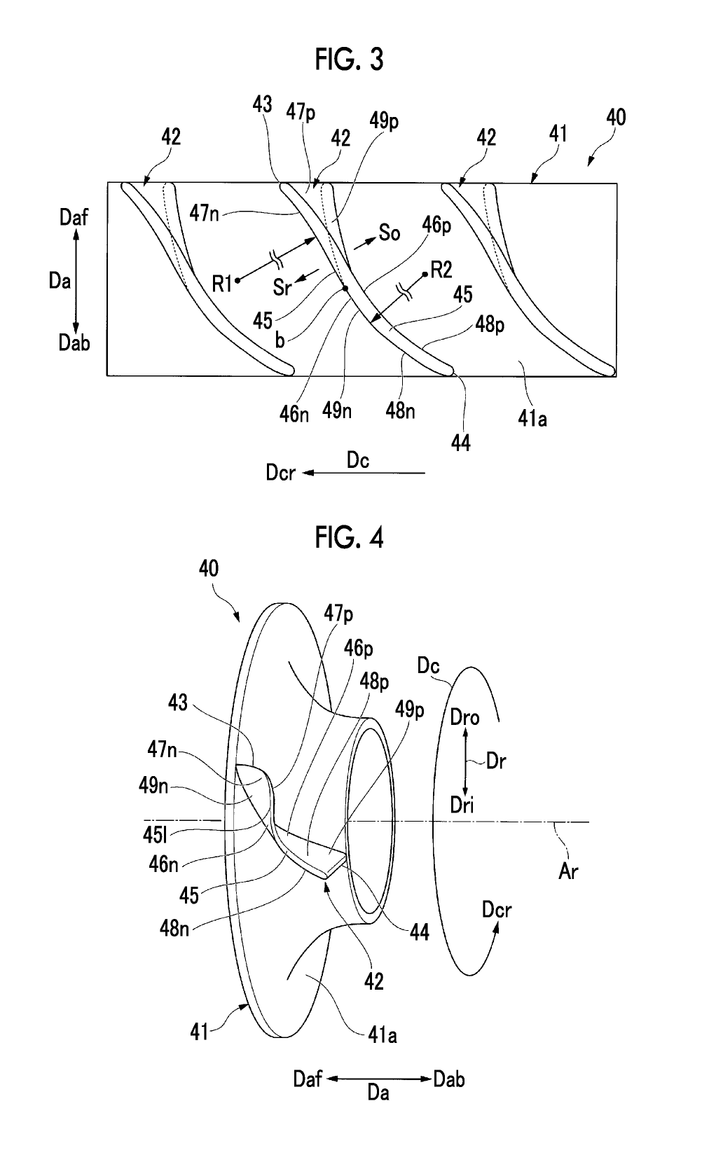

Here, a side from the pressure surface 46p toward the suction surface 46n is referred to as a rotation side Sr (refer to FIG. 3). In addition, a side from the suction surface 46n toward the pressure surface 46p is referred to as an counterrotation side So.

As shown in FIG. 3, when the blade 42 is viewed in the radial direction, the leading edge side of blade tip 47n forms a concave curved surface which is recessed to the counterrotation side So. When the blade 42 is viewed in the radial direction, the trailing edge side of blade tip 48n forms a convex curved surface which protrudes to the rotation side Sr. When the blade 42 is viewed in the radial direction, the root portion 49n of the suction surface 46n forms a convex curved surface which protrudes to the rotation side Sr.

For example, a curvature radius R1 of the concave curved surface in the leading edge side of blade tip 41n is equal to or more than a curvature radius R2 of the convex curved surface in the trailing edge side of blade tip 48n. Moreover, for example, a boundary line b between the leading edge side of blade tip 47n and the trailing edge side of blade tip 48n on a tip line 45l formed at a boundary between the tip 45 and the suction surface 46n is positioned at a position at which a distance from the leading edge 43 to the boundary line b is equal or more than half the entire length of the tip line 45l. In addition, as shown in FIG. 2, a boundary line between the leading edge side of blade tip 47n and the root portion 49n is positioned at a position which is less than half a blade height from the tip 45 in a blade height direction.

Similarly to the suction surface 46n, as shown FIGS. 2 and 4, the pressure surface 46p includes a leading edge side of blade tip 47p, a trailing edge side of blade tip 48p, and a root portion 49p. The leading edge side of blade tip 47p is a portion which includes a boundary between the tip 45 and the pressure surface 46p, and the leading edge 43. The trailing edge side of blade tip 48p is in contact with the leading edge side of blade tip 47p and is a portion which includes the boundary between the tip 45 and the pressure surface 46p, and the trailing edge 44. The root portion 49p is in contact with the leading edge side of blade tip 47p and the trailing edge side of blade tip 48p, and is a portion which includes a boundary between the outer peripheral surface 41a of the disk 41 and the pressure surface 46p, the leading edge 43, and the trailing edge 44. In the pressure surface 46p, the leading edge side of blade tip 47p, the trailing edge side of blade tip 48p, and the root portion 49p do not overlap each other.

As shown in FIG. 3, when the blade 42 is viewed in the radial direction, the leading edge side of blade tip 47p of the pressure surface 46p forms a convex curved surface which protrudes to the counter-rotation side So. When the blade 42 is viewed in the radial direction, the trailing edge side of blade tip 48p of the pressure surface 46p forms a concave curved surface which is recessed to the rotation side Sr. When the blade 42 is viewed in the radial direction, the root portion 49p of the pressure surface 46p forms a concave curved surface which is recessed to the rotation side Sr.

As shown in FIG. 1, the turbine housing 32 includes a wheel chamber 33 in which the turbine wheel 40 is rotatably accommodated, a scroll flow path 34 to which a working fluid F (EX) flows, and an exhaust port 35 to which the working fluid F is exhausted. The scroll flow path 34 is a flow path which extends in a direction including a circumferential components. The scroll flow path 34 is a portion on the axially rear side Dab of the wheel chamber 33 and communicates with the wheel chamber 33 at a portion on the radially outer side Dro of the wheel chamber 33. The working fluid F which has flowed into the scroll flow path 34 flows from the radially outer side Dro into the wheel chamber 33 through the communication portion. The wheel chamber 33 is open at an end on the axially rear side Dab. This opening is the above-described exhaust port 35. The working fluid F which has flowed into the wheel chamber 33 is exhausted form the exhaust port 35.

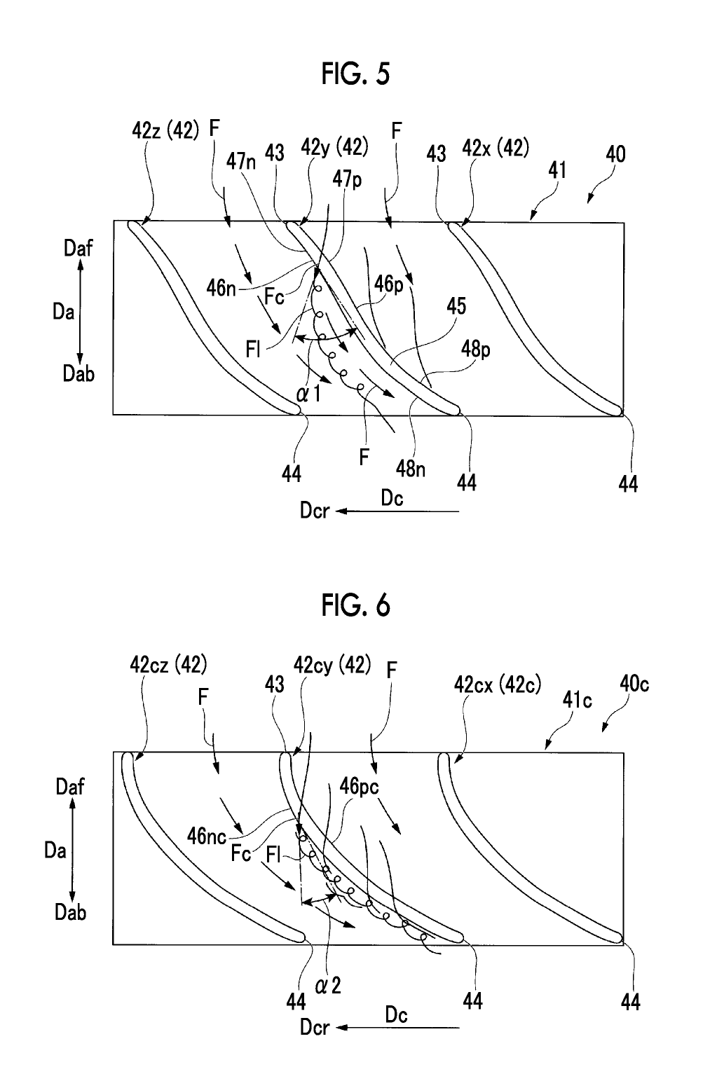

As shown in FIG. 5, the working fluid F which has flowed into the wheel chamber 33 flows from a portion between the leading edges 43 of the respective blades 42 into a portion between the blades 42 in the turbine wheel 40. The working fluid F which has flowed into the portion between the blades 42 flows out from a portion between the trailing edges 44 of the respective blades 42. In a process in which the working fluid F flows through the portion between the blades 42, the working fluid F imparts a rotational force to the turbine wheel 40. In addition, in the present embodiment, the working fluid F is the exhaust

There is a gap referred to as a tip clearance Ct (refer to FIG. 2) between the tip 45 of the blade 42 and a portion facing the tip 45 on an inner peripheral surface of the turbine housing 32. In order to increase turbine efficiency, it is preferable to set the tip clearance Ct as small as possible. However, due to axial vibrations, thermal expansion of the turbine wheel 40, or the like, there is a limit to a reduction of the tip clearance Ct to avoid a contact risk between the tip 45 of the blade 42 and the inner circumferential surface of the turbine housing 32.

The flow of the working fluid F extracted from the tip clearance Ct, that is, a presence of a clearance flow causes a decrease in the turbine efficiency. Accordingly, it is preferable to reduce to the clearance flow.

Here, before the clearance flow in the present embodiment is described, a clearance flow in a turbine wheel of Comparative Example will be described with reference to FIG. 6.

A turbine wheel 40c of Comparative Example also includes a disk 41c and a plurality of blades 42c. The entire pressure, surface 46pc of each of the blades 42c forms a concave curved surface which is recessed to the rotation side Sr. In addition, the entire suction surface 46nc of each of the blades 42c forms a convex curved surface which protrudes to the rotation side Sr.

As described above, most of the working fluid F which has flowed into a portion between a first blade 42cx and a second blade 42cy adjacent to each other in the circumferential direction Dc flows out from a portion between the trailing edges 44 of the blades 42cx and 42cy. However, a portion of the working fluid F flows from a pressure surface 46pc of the second blade 42cy to a suction surface 46ne side of the second blade 42cy via the tip clearance Ct in the second blade 42cy, as a leakage fluid Fl. That is, a portion of the working fluid F flows into a portion between the second blade 42cy and a third blade 42cz via the tip clearance Ct in the second blade 42cy, as the leakage fluid Fl.

The leakage fluid Fl which has flowed into the portion between the second blade 42cy and the third blade 42cz becomes a vortex flow, is attached to the suction surface 46nc of the second blade 42cy, and flows along the suction surface 46nc. The clearance flow is attracted by the flow of the leakage, fluid Fl along the suction surface 46nc of the second blade 42cy. Therefore, due to the clearance flow Fc generated in the portion on the leading edge 43 side of the second blade 42cy, a clearance flow is also generated in an intermediate portion between the leading edge 43 and the trailing edge 44 of the second blade 42cy. Due to the attracted clearance flow, leakage fluid Fl which has flowed into a portion between the second blade 42cy and the third blade 42cz also becomes a vortex flow and flows along the suction surface 46nc of the second blade 42cy. The clearance flow is also attracted by the flow of the leakage fluid Fl along the suction surface 46nc of the second blade 42cy. Accordingly, the clearance flow is generated in a portion on the trailing edge 44 side of the second blade 42cy by the clearance flow generated in an intermediate portion of the second blade 42cy.

That is, in Comparative Example, the clearance flow is generated in the entire blade 42c from the leading edge 43 to the trailing edge 44 of the blade 42c.

Next, the clearance flow in the present embodiment will be described with reference to FIG. 5.

In the present embodiment, as the leakage fluid Fl, a portion of the working fluid F which has flowed into a portion between a first blade 42x and a second blade 42y flows from the pressure surface 46p side of the second blade 42y into the suction surface 46n side of the second blade 42y through the tip clearance Ct in the second blade 42y on the leading edge 43 side of the second blade 42y. That is, as the leakage fluid Fl, a portion of the working fluid F flows into the portion between the second blade 42y and the third blade 42z through the tip clearance Ct in the portion on the leading edge 43 side of the second blade 42y.

In the present embodiment, the leakage fluid Fl which has flowed into the portion between the second blade 42y and the third blade 42z becomes a vertex flow. However, in the present embodiment, most of the leakage fluid Fl is separated from the suction surface 46n of the second blade 42y and flows to the trailing edge 44 sides of the blades 42y and 42z through a portion between the second blade 42y and the third blade 42z.

The entire suction surface 46n of Comparative Example is the convex curved surface which protrudes to the rotation side Sr. Meanwhile, the leading edge side of blade tip 47n in the suction surface 46n of the present embodiment is the concave curved surface which is recessed to the counterrotation side So. Accordingly, a separation angle α1 of the clearance flow Fc with respect to the suction surface 46nc in the present embodiment is larger than a separation angle α2 of the clearance flow Fc with respect to the suction surface 46nc in Comparative Example. In addition, the separation angle α is an angle between a tangent with respect to the suction surface at a position where the clearance flow Fc crosses the boundary between the suction surface and the tip, and the clearance flow Fc. Accordingly, in the present embodiment, most of the leakage fluid Fl which has flowed into the portion between the second blade 42v and the third blade 42z through the tip clearance Ct in the portion on the leading edge 43 side of the second blade 42y is not attached to the suction surface 46n of the second blade 42y, and flows to be separated from the suction surface 46n. The working fluid F which has flowed into the portion between the second blade 42y and the third blade 42z flows into a portion between the flow of the leakage fluid Fl and the suction surface 46n of the second blade 42y.

As a result, in the present embodiment, even when the clearance flow Fc is generated in the portion on the leading edge 43 side of the second blade 42y, a new clearance flow Fc is not attracted by the clearance flow Fc. Accordingly, compared to Comparative Example, in the present embodiment, it is possible to reduce the clearance flow Fc and increase the turbine efficiency.

Meanwhile, if a size of the radial turbine 30 decreases, in general, the tip clearance Ct decreases. However, even when the size of the radial turbine 30 decreases, the tip clearance Ct does not become so small. The reason for this is that, as described above, the tip clearance Ct is a gap for avoiding contact between the tip 45 of the blade 42 and the inner peripheral surface of the turbine housing 32 due to the axial vibrations, the thermal expansion of the turbine wheel 40, or the like. Therefore, a ratio of the tip clearance Ct with respect to a length of the leading edge 43 or a length of the trailing edge 44 increases as the size of the radial turbine 30 decreases. Accordingly, as the size of the radial turbine 30 decreases, a ratio of a flow rate of a clearance flow with respect to a flow rate of the working fluid F flowing into the radial turbine 30 increases.

Accordingly, for example, in the radial turbine 30 used for the turbocharger for medium or small passenger cars, in order to increase a reduction rate of the clearance flow, as described above, preferably, the boundary line b on the tip line 45l between the leading edge side of blade tip 47n and the trailing edge side of blade tip 48n in the suction surface 46n is positioned at the position at which the distance of the boundary line b from the leading edge 43 is equal to or more than half the entire length of the tip line 45l. In addition, as described above, preferably, the curvature radius R1 of the concave curved surface in the leading edge side of blade tip 47n is equal to or more than the curvature radius R2 of the convex curved surface in the trailing edge side of blade tip 48n.

### INDUSTRIAL APPLICABILITY

In an aspect of the present invention, it is possible to reduce the clearance flow.

### REFERENCE SIGNS LIST

10: compressor

11: compressor rotary shaft

12: compressor housing

16: compressor impeller

20: connection portion

21: connection rotary shaft

22: center housing

23: bearing

30: radial turbine

31: turbine rotary shaft

32: turbine housing

33: wheel chamber

34: scroll flow path

35: exhaust port

40: turbine wheel

41: disk

41a: outer peripheral surface

42: blade

43: leading edge

44: trailing edge

45: tip

45l: tip line

46n: suction surface

46p: pressure surface

47n, 47p: leading edge side of blade tip

43n, 48p: trailing edge side of blade tip

49n, 49p: root portion

Ct: tip clearance

F: working fluid

Fc: clearance flow

Fl: leakage fluid

Ar: axis

Da: axial direction

Dab: axially rear side

Daf: axially front side

Dc: circumferential direction

Dr: radial direction

Dri: radial inner side

Dro: radially outer side

Sr: rotation side

So: counterrotation side

1. A turbine wheel comprising:
a disk which has a shape rotationally symmetrical about an axis and a diameter which gradually decreases from a front side which is one side in an axial direction in which the axis extends toward a rear side which is the other side;
a plurality of blades which are fixed to an outer peripheral surface of the disk at intervals in a circumferential direction D with respect to the axis,
wherein each of the blades includes
a leading edge which extends in a direction including an axial component from a portion on the front side of the disk and faces a radially outer side with respect to the axis,
a trailing edge which extends in a direction including a radial component with respect to the axis from a portion on the rear side of the disk and faces the rear side,
a pressure surface and a suction surface which extend from the leading edge to the trailing edge and face sides opposite to each other,
a tip which forms an edge on a side far from the outer peripheral surface,
wherein the suction surface includes a leading edge side of blade tip including a boundary between the suction surface and the tip and the leading edge and a trailing edge side of blade tip including a boundary between the suction surface and the tip and the trailing edge,
wherein the leading edge side of blade tip forms a concave curved surface which is recessed to an counterrotation side from the suction surface toward the pressure surface when viewed in a radial direction, and
wherein the trailing edge side of blade tip forms a convex curved surface which protrudes to a rotation side from the pressure surface toward the suction surface side when viewed in the radial direction.

2. The turbine wheel according to claim 1,
wherein the suction surface has a root portion which includes a boundary between the suction surface and the outer peripheral surface; the leading edge, and the trailing edge, and is in contact with the leading edge side of blade tip and the trailing edge side of blade tip , and
wherein the root portion forms a convex curved surface which protrudes to the rotation side.

3. The turbine wheel according to claim 2,
wherein a boundary line between the leading edge side of blade tip and the root portion is positioned at a position which is less than half a blade height from the tip in a blade height direction.

4. The turbine wheel according to claim 1,
wherein the leading edge side of blade tip and the trailing edge side of blade tip are in contact with each other, and
wherein a boundary line between the leading edge side of blade tip and the trailing edge side of blade tip on a tip line formed at a boundary between the tip and the suction surface is positioned at a position at which a distance from the leading edge to the boundary line is equal or more than half the entire length of the tip line.

5. The turbine wheel according to claim 1,
wherein a curvature radius of the concave curved surface in the leading edge side of blade tip is equal to or more than a curvature radius of the convex curved surface in the trailing edge side of blade tip.

6. The turbine wheel according to claim 1,
wherein the pressure surface includes a leading edge side of blade tip including a boundary between the pressure surface and the tip and the leading edge and a trailing edge side of blade tip including a boundary between the pressure surface and the tip and the trailing edge,
wherein the leading edge side of blade tip of the pressure surface forms a convex curved surface which protrudes to the counterrotation side when viewed in the radial direction, and
wherein the trailing edge side of blade tip of the pressure surface forms a concave curved surface which is recessed to the rotation side when viewed in the radial direction.

7. A radial turbine comprising:
the turbine wheel according to claim 1;
a turbine rotary shaft which extends in the axial direction about the axis and to which the turbine wheel is fixed; and
a turbine housing which covers the turbine wheel to be rotatable.

8. A turbocharger comprising:
the radial turbine according to claim 7; and
a compressor,
wherein the compressor includes
a compressor rotary shaft which is rotated about the axis,
an impeller which is fixed to the compressor rotary shaft, and
a compressor housing which covers the impeller,
wherein the turbine rotary shaft and the compressor rotary shaft are positioned on the same axis to be connected to each other and are integrally rotated with each other to form a turbocharger rotary shaft.
